(19) United States
(12) Patent Application Publication
(10) Pub. No.: US 2014/0020636 A1
(43) Pub. Date: Jan. 23, 2014

(54) Behavioral Identification Accessory for Animals

(71) Applicant: Karen Desaulniers, Brewster, NY (US)

(72) Inventor: Karen Desaulniers, Brewster, NY (US)

(21) Appl. No.: 13/947,728

(22) Filed: Jul. 22, 2013

Related U.S. Application Data
(60) Provisional application No. 61/674,026, filed on Jul. 20, 2012.

(51) Int. Cl. A01K 27/00

(52) U.S. Cl. CPC A01K 27/006
USPC 119/858

(57) ABSTRACT

An animal safety accessory is provided for warning those around an animal of its behavior patterns. The device is a color coded neck collar style accessory with a bib portion extending therefrom. A message indicia is displayed on the front surface of the bib portion. Illumination means such as LED lights are also disposed along the collar and bib portion. The message indicia, lights, and color coding indicate to passersby whether the wearer animal is friendly, shy, aggressive or the like. In this manner, the device is warning system that alerts persons as to whether or not they may approach and engage an animal

### CROSS REFERENCE TO RELATED APPLICATION

This application claims the benefit of U.S. Provisional Application No. 61/674,026 filed on Jul. 20, 2012 entitled “K-Kollar.”The patent application identified above is incorporated here by reference in its entirety to provide continuity of disclosure.

### BACKGROUND OF THE INVENTION

1. Field of the Invention

The present invention relates to animal safety accessories. More specifically, it relates to a collar accessory that includes indicia and illuminators that inform third parties about the animal's behavioral tendencies. The collar has an attached bandana that is color coded to indicate whether the wearer is friendly or hostile towards strangers. Similarly, the indicia and illuminators also indicate to passersby whether the animal is comfortable being approached by other animals or humans. The collar will be appreciated by pet owners who walk their animals in public areas.

Pet owners have long experienced difficulties associated with exercising their pets. Often, daily exercise for a pet includes one or more daily walks. These walks benefit both the owner and the pet, which experience bonding time and physical exercise. Walking and exercising together increases the fitness of both owner and strengthens their relationship. The more often the pet and owner exercise, the greater the benefits they both experience.

Training a pet to walk alongside its owner usually involves the use of a lead line or leash and collar assembly. The collar is gently secured around the pet's neck and is connected to a leash. Most leashes have a loop disposed at the free end, thereby providing a handle for the owner to grasp. The owner holds this loop and guides the pet during a walk. Correction of undesirable or inappropriate behaviors is made by the owner via short, sharp tugs on the leash. Over time the pet learns to associate the bad behavior with the sharp tug, and ceases the undesirable action.

The most egregious animal behavior is that of hostility towards other animals and persons. Unsocialized pets may act aggressively and even attack passersby without providing much warning to the owner. For this reason, it is difficult for those around the pet to know whether it is safe to approach the animal. Visible signs such as flattened ears and raised fur may not be readily apparent in all animals practicing aggressive behavior.

A visually distinct means of identifying whether an animal is safe to approach is needed. The present invention provides a collar with a color coded bandana portion that features illuminators and indicia. The indicia, illuminators, and color are designed to provide quick visual confirmation to third parties regarding the animal's friendliness. Thus, passersby can maintain a safe distance from unfriendly animals and avoid potential attacks.

### DESCRIPTION OF THE PRIOR ART

The present invention is a safety accessory for animals. It is a collar with a front bib portion. Illumination lights and indicia are displayed on the bib so as to provide passersby with visual warning of the animal's behavioral disposition. In addition to these indicators, the bib and collar are color coded for added visual indication. The prior art does not disclose animal safety accessories having a bib section with indicia and illuminators. The following prior art is considered to be a list of devices relevant to the present disclosure, and is not meant to be exhaustive.

Dog collars with visible indicia are often used to indicate the name or job of the wearer animal. Aebi, U.S. Patent Publication No. 2007/0022974 teaches a dog collar and leash that have warning indicia displayed thereon. Words such as “caution: dog” or “danger” may be prominently displayed along the band of the dog collar or the accompanying leash. Similarly cautionary patterns such as yellow and black strips are displayed to indicate to passersby that the dog is dangerous. Though Aebi is relevant to the present disclosure it fails to teach the bib portion or indicator lights of the present invention.

Warning vests have also been designed to prevent onlookers from engaging animals. Working animals such as dogs, miniature horses, and pigs that guide disabled persons often wear vests depicting messages warning others that the animal is working and is not approachable. Another example is a medical warning vest shown in Tacker, U.S. Design Patent No. D652,583 and D652,582 depicting visual indicia that the animal has medical problems and may be injured by petting or high stress situations. Reflective pet safety vests are also available, as shown in Constans, U.S. Design Patent No. D455,873. Though these devices are relevant to the present disclosure they do not teach a collar or bib portion.

The cited devices do now disclose the bib structure of the present invention. Nor do they disclose illumination means capable of lighting up a portion of the bib. These features provide greater visibility to children and greater visibility at night. In this way, the present invention is an improvement over the devices now available in the art.

These prior art devices have several known drawbacks. They do not provide a pet collar that is easily visible to small children. Likewise, the prior art devices do not feature any illumination means that improves night-time visibility. The present invention solves these problems by providing a large bib surface upon which lights and indicia are displayed. It substantially diverges in design elements from the prior art and consequently it is clear that there is a need in the art for an improvement to existing pet safety accessory devices. In this regard the instant invention substantially fulfills these needs.

### SUMMARY OF THE INVENTION

In view of the foregoing disadvantages inherent in the known types of pet safety accessories now present in the prior art, the present invention provides a new large bib region and illumination means wherein the same can be utilized for providing convenience for the user when walking the pet near small children or in the dark.

The animal safety accessory device is designed to inform persons in the area surrounding an animal as to the animal's behavioral tendencies. To accomplish this goal, illuminating lights, warning signs, and brightly colored materials are employed. Color coded materials and warning signs will visible to users or all ages from a distance of at least several feet. Illuminating lights are advantageous during night-time or rainy day walks, where visibility is low. Once alerted by the visual signals, passersby can elect whether to approach the animal.

The animal safety accessory is worn about an animal's neck or ankle and has a collar and bib configuration. A band style collar is used to removably secure the safety device to the pet. Along the front and sides of the band a bib hangs down, covering a portion of the animal's chest or paw region. This bib has various warning signs displayed thereon. Illumination means such as LED lights are disposed along the bib. To activate these lights a power button connected to a battery, is positioned along the collar or bib. Depressing this button initiates illumination patterns such as blinking or steady illumination.

Different forms of visual signal are used in order to warn persons of varied types. Most passersby will identify the accessory by its collar, bib indicia, and lights. Children will find it easiest to identify brightly colored materials and largely displayed indicia on the bib. Night time pedestrians and those with poor visual acuity will easily identify the lights disposed on the bib. In this manner, the device succeeds in warning persons that conventional warning methods might not reach.

It is therefore an object of the present invention to provide a new and improved animal safety accessory device that has all of the advantages of the prior art and none of the disadvantages.

It is therefore an object of the present invention to provide an animal safety device that warns persons in the surrounding environment as to the behavioral tendencies of the wearer animal.

Another object of the present invention is to provide an animal safety collar that has illuminating means visible at night.

Yet another object of the present invention is to provide a warning means that can be understood by small children.

Still another object of the present invention is to provide a visual notification to third parties that an animal is aggressive.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a frontal view of one embodiment of the animal safety accessory. The warning indicia can be illuminated to increase visibility of the warning.

FIG. 2 shows a perspective view of another embodiment of the animal safety accessory device. The warning sign is distinct from the multiple illuminating lights.

FIG. 3 shows a perspective view of the animal safety accessory in use. One dog wears a blinking device and stands in an aggressive position, while the other dog is wearing a dormant device, sitting calmly. Thus the use of the device for signaling hostility of an animal is shown.

### DETAILED DESCRIPTION OF THE INVENTION

Reference is made herein to the attached drawings. Like reference numerals are used throughout the drawings to depict like or similar elements of the animal safety accessory. For the purposes of presenting a brief and clear description of the present invention, the preferred embodiment will be discussed as used for warning third parties about animal behavioral tendencies. The figures are intended for representative purposes only and should not be considered to be limiting in any respect.

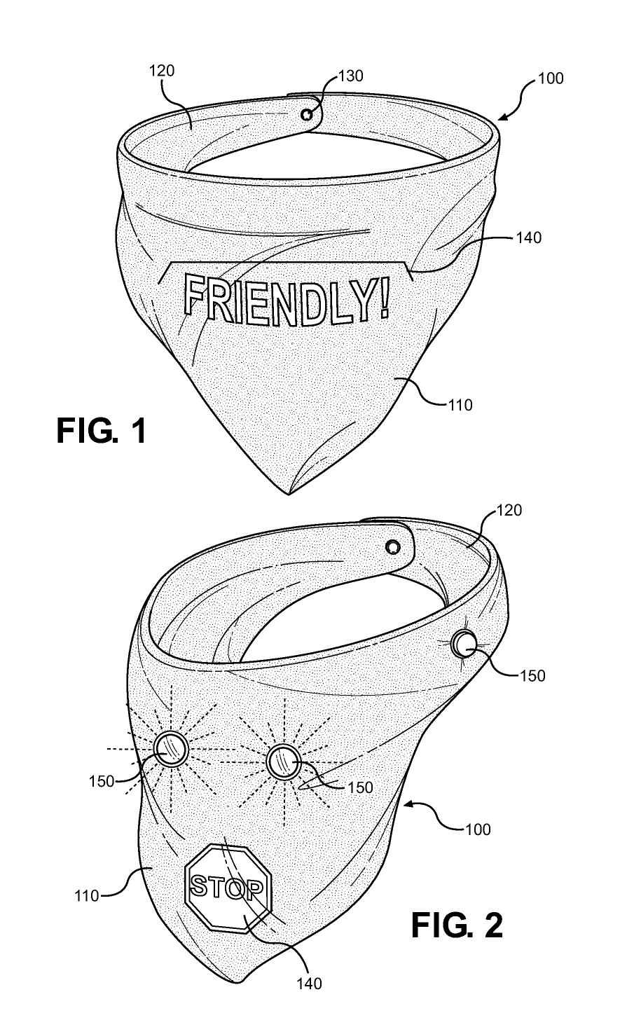

Referring now to FIG. 1, there is shown a front view of an animal safety accessory. The device 100 is a collar style accessory that removably fastens around the neck or ankle of an animal when in use. A collar band 120 has a pair of fasteners 130 disposed at opposing ends. These fasteners mate together to bring the band into an encircling collar shape. Extending downward from the sides and front of the collar is a bib portion 110. The bib increases in height as it extends from the sides toward the front of the collar band. Thus the front of the bib is significantly larger in height than the sides.

On the front of the bib portion a message indicia 140 is displayed. This message indicates to a reader that the accessory color scheme is representative of whether the wearer animal is receptive to approach. Further indication may be provided by a green, yellow or red coloring of the accessory. This color is selected for exemplary purposes due to its general association with “go” and “continue.” The color of the illumination means is matched to the color of the accessory.

Message indicia are displayed on the bib portion in via a variety of techniques. In the depicted example, the message indicia have illumination means disposed behind the lettering, within the bib portion. The lettering itself is transparent or translucent. When the illumination means is activated, the message letters light up, rendering them easily visible in the dark.

The bib portion itself is preferably two pieces of fabric forming a front and back surface and having an interior region. Within the interior region, illumination means such as light emitting diodes are stored, along with a battery and an activation button. These elements are electrically connected together such that engagement of the activation button results in illumination of the lights. It is also contemplated that multiple engagements of the power button cause the illumination means to cycle through different illumination patterns, with the cycle ending in a powered off state. Such electrical cycles are known in the art of simple electrical engineering and can be configured without significant testing or trial.

Turning now to FIG. 2, there is shown another embodiment of the animal safety accessory. The device 100 has a collar band 120 fastened into a circle by a pair of fasteners. A bib portion 110 extends from the collar band. Bib material may be attached to a lower edge of the collar band or may be an extension of a material sheath that encloses the collar band.

In this embodiment, the illumination means 150 are separate from the warning indicia 140. The illumination means protrude from the surface of the bib portion rather than being hidden within the bib material. Electrical connection for these lights is hidden between the layers of the bib portion, but the lights themselves are visible about the top of the front surface. Lights may be disposed along the bib portion as well as along the collar band. Bib positioning of the illumination means is preferable because these indicators are less likely to be obscured by long fur.

A message indicia is disposed below the lights. This message indicia 140 indicates to passersby that the accessory is an indicator as to whether the dog is dangerous or unfriendly and should not be approached. Bib material is colored red to further indicate that caution should be taken in approaching the animal.

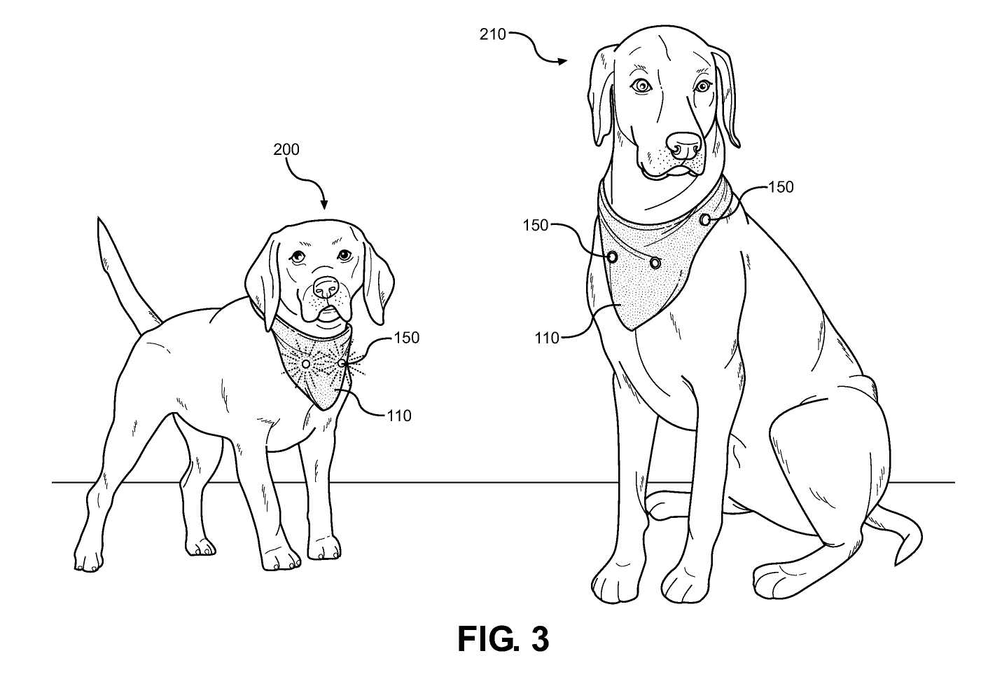

Referring finally to FIG. 3, there is shown a view of the animal safety accessory in use. A first dog 220 is wearing a red colored device with a bib 110 that extends down over the dog's chest. Red lights 150 on the bib portion are illuminated to indicate that the dog is hostile. The dog itself stands with tail alert and feet wide, in an aggressive stance. A second dog 210 has a green device with a bib portion 110 extending downward over the dog's chest. The lights on this bib and collar band are not illuminated , but can be activated by the caregiver at any time. The dog's body language indicates that he is calm, sitting peacefully in a passive and relaxed state.

The present invention is an animal safety accessory that is designed to increase awareness of pedestrians as to the nature of animals around them. Several visual indicia are provided to notify persons that a particular wearer is safe to approach and engage or alternatively is dangerous. The device has a collar band which may have a fixed length or may be adjustable. Adjustable versions include an H-style bracket through which a portion of the band is threaded to facilitate resizing.

The overall message conveyed by the device will vary according to the specific version needed by a user. By way of example, one device conveys the message that a dog is friendly and enjoys interaction with others, while another device may be color coded and marked to indicate that the dog is shy and persons should approach slowly. Still other devices may indicate that the dog is hostile towards humans, other animals, or both.

Various materials may be used in the construction of the device. The collar band may be leather, rubber, web material, nylon, or other material commonly used in the construction of animal collars. The bib portion is a cloth material that encircles and houses the collar band or alternatively is attached thereto. Thus the device is a light weight and versatile accessory.

To this point, the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. An animal safety accessory, comprising:
a collar band having a first and second end;
mating fasteners disposed at said first and second end of said collar band;
a bib portion extending downward from said collar band, and having a front surface and a rear surface and an interior region disposed therebetween;
illumination means electrically connected to a battery and an activation button.

2. The animal safety accessory of claim 1, wherein said bib portion extends furthest from said collar band along the center of said band, and tapers towards the ends of said collar band.

3. The animal safety accessory of claim 1, wherein said collar band is sheathed within said interior region.

4. The animal safety accessory of claim 1, wherein said bib portion is attached to said collar band.

5. The animal safety accessory of claim 1, wherein said illumination means are disposed within said bib portion and behind said warning message indicia, such that activation of said illumination means illuminates said warning message indicia.

6. The animal safety accessory of claim 1, wherein said illumination means is disposed along said bib portion and protrudes from said front surface.

7. The animal safety accessory of claim 1, wherein said illumination means is disposed along said collar band.

8. The animal safety accessory of claim 1, wherein said illumination means is light emitting diodes.

9. The animal safety accessory of claim 1, further comprising a warning indicia displayed on said bib portion.

10. The animal safety accessory of claim 1, wherein said collar band is adapted to be secured around the neck of an animal.

11. The animal safety accessory of claim 1, wherein said collar band is adapted to be secured around the ankle of an animal.
